(19) United States
(12) Patent Application Publication
(10) Pub. No.: US 2007/0088562 A1
(43) Pub. Date: Apr. 19, 2007

(54) Method and program product for identifying educational content for a business initiative

(75) Inventors: John F. Hollingsworth, Wynnewood, PA (US); Jeffrey W. Mersereau, Tehachapi, CA (US)

Correspondence Address: SILVY ANNA MURPHY, 100 TURNBERRY LANE, CARY, NC, 27511, US

(73) Assignee: International Business Machines Corporation, Armonk, NY (US)

(21) Appl. No.: 11/253,021

(22) Filed: Oct. 18, 2005

(51) Int. Cl. G06Q 99/00

(52) U.S. Cl. 705/1

(57) ABSTRACT

A method and program product for identifying educational content and skill requirements for a business initiative is provided. The method includes defining a business initiative having a framework with predefined levels of skill. Further, for each of the predefined levels of skill, the method includes identifying one or more standard skills for a plurality of skilled workers, and for each of the one or more standard skills identified for each of the plurality of skilled workers, the method further includes determining whether any business initiative specific skills are required by any of the plurality of skilled workers who will be implementing the business initiative, and identifying at least one education module required to provide education for any business initiative specific skills determined to be required by at least one of the plurality of skilled workers who will be implementing the business initiative.

### FIELD OF THE INVENTION

The present invention relates to a method for identifying educational content and skill requirements. More particularly, the present invention relates to a method and computer program product for identifying and/or developing educational content required for implementing a new business initiative or a new business technique.

### BACKGROUND OF THE INVENTION

In any business, new initiatives are regularly introduced in order to be the first to apply new technologies or to grow existing markets. Significant funding is spent on the development of a new business initiative, for instance, in leadership, creation of assets, reference architectures and sales/consulting models. The deployment of an initiative is seldom as well constructed or funded as the development. Training and education is often done unsystematically, resulting in a workforce that is not adequately prepared to deploy the new business initiative that was methodically developed. As such, there is a need for proficient way to deploy or implement a business initiative that has been developed, so that resources can be managed more effectively and efficiently.

### SUMMARY OF THE INVENTION

In a first aspect of the invention, there is provided a method for identifying educational content. The method includes the steps of defining a business initiative having a framework with predefined levels of skill. Further, for each of the predefined levels of skill, the method includes identifying one or more standard skills for each of a plurality of skilled workers, and for each of the one or more standard skills identified for each of the plurality of skilled workers, the method further includes determining whether any business initiative specific skills are required by any of the plurality of skilled workers who will be implementing the business initiative, and identifying at least one education module required to provide education for any business initiative specific skills determined to be required by at least one of the plurality of skilled workers for implementing the business initiative. The method further includes the step of developing one or more new education modules required to provide education corresponding to any business initiative specific skills determined to be required for implementing the business initiative. Furthermore, the method includes the step of displaying a skill level of educational content provided by the one or more new education modules developed to provide education for implementing the business initiative. Preferably, the one or more business initiative specific skills are derived from the one or more standard skills identified for each skilled worker. Preferably, the predefined level of skill includes an overview level, a foundation level and an enhanced level. Further, the step of identifying one or more standard skills includes, for each of the predefined levels of skill, identifying one or more professions for the plurality of skilled workers who will be implementing the business initiative, and for each of the one or more professions identified, identifying one or more associated disciplines and for each of the one or more associated disciplines identified, identifying one or more associated job roles. Preferably, the identifying at least one new education module step includes establishing a job role skill set for each of the plurality of skilled workers, such that the job role skill set can be used to develop the one or more new education modules required to provide education for implementing the business initiative. More preferably, the identifying at least one education module step includes performing an inventory of current education modules that can be used to provide education for implementing the business initiative and identifying gaps in the current education modules based on any business initiative specific skills determined to be required for implementing the business initiative. Further, the identifying at least one education module step includes grouping the one or more business initiative specific skills determined to be required for implementing the business initiative into one or more groups of business initiative specific skills, such that the at least one education module identified can provide education as to one of the one or more groups of business initiative specific skills. Preferably, the method further includes the steps of entering into a tool each of the one or more standard skills identified for the plurality of skilled workers who will be implementing the business initiative and entering into the tool each of any business initiative specific skills determined to be required by any of the plurality of skilled workers who will be implementing the business initiative.

In another aspect of the invention, there is provided a method for developing educational content for deploying a business initiative. The method includes the steps of defining a business initiative that has a plurality of predefined levels of skill that are established for the business initiative. For each of the predefined levels of skill, the method further includes identifying one or more standard skills for each of a plurality of skilled workers, for each of the one or more standard skills identified for each of the plurality of skilled workers, the method includes determining whether any business initiative specific skills are required for any of the plurality of skilled workers for deploying the business initiative. Further, the method includes identifying educational gaps in available educational content for providing education as to any business initiative specific skills determined to be required for any of the plurality of skilled workers for deploying the business initiative and developing one or more new education modules based on the educational gaps identified, such that the one or more new education modules provide education for one or more of the plurality of skilled workers as to any business initiative specific skills determined to be required for deploying the business initiative. Preferably, the identifying one or more standard skills step includes, for each of the plurality of predefined levels of skill, identifying one or more professions for the plurality of skilled workers for deploying the business initiative, for each of the one or more professions identified, identifying one or more associated disciplines and for each of the one or more associated disciplines identified, identifying one or more associated job roles. More preferably, the identifying educational gaps step includes performing an inventory of the available education modules that can be used to provide education for deploying the business initiative. Further, the developing step preferably includes grouping any business initiative specific skills determined to be required into one or more groups of business initiative specific skills, such that each of the one or more new education modules developed provides education as to at least one of the one or more groups of business initiative specific skills and displaying a skill level for educational content provided by each of the one or more new education modules. Preferably, the plurality of predefined levels of skill includes an overview level, a foundation level and an enhanced level.

In yet another aspect of the invention, there is provided a computer program product for identifying educational content for implementing a business initiative. The computer program product includes a computer readable medium, first program instructions to access a set of skilled worker skills required for a skilled worker among a plurality of skilled workers, second program instructions to assess individual skill levels of the skilled worker with respect to the set of skilled worker skills accessed for implementing the business initiative, and third program instructions to identify whether any education modules are required by the skilled worker based on the individual skill levels assessed for the skilled worker who will be implementing the business initiative. Further, the computer program product further includes fourth program instructions to evaluate a set of business factors pertaining to the capability of a business to implement the business initiative. Preferably, the first, second, third and fourth program instructions are stored on the medium. The first program instructions further include instructions to receive in a memory one or more standard skills required for each skilled worker among the plurality of skilled workers for implementing the business initiative and to receive in the memory any business initiative specific skills required for any of the plurality of skilled workers who will be implementing the business initiative. Furthermore, the second program instructions include instructions to provide a list of available skilled workers for a job role, such that any one on the list of available skilled workers can implement the business initiative. Additionally, the third program instructions include instructions to perform an inventory of available education modules to identify gaps in the available education modules for determining any new education modules required for implementing the business initiative. Preferably, the set of skilled worker skills includes standard skills required for each skilled worker among the plurality of skilled workers and business initiative specific skills required by any of the plurality of skilled workers for implementing the business initiative.

### BRIEF DESCRIPTION OF THE DRAWINGS

The accompanying drawings, which are incorporated in and form a part of this specification, illustrate embodiments of the invention and, together with the description, serve to explain the principles of the invention

FIG. 1 is a schematic block diagram illustrating a method of defining a business initiative or technique having a framework with a plurality of predefined levels of skill, in accordance with an embodiment of the invention.

FIG. 2 is a schematic block diagram illustrating applying a method of defining a business initiative or technique having a framework with a plurality of predefined levels of skill to unique business requirements, in accordance with an embodiment of the invention.

FIGS. 3A-3B are illustrations of a flowchart depicting a method of identifying and developing educational content required for implementing a business initiative or technique, in accordance with an embodiment of the invention.

FIG. 4 is a schematic block diagram illustrating a method of identifying a plurality of standard skills for a plurality of skilled workers for implementing any business initiative that has a framework with predefined levels of skill, in accordance with an embodiment of the invention.

FIG. 5 is a schematic block diagram illustrating a method of determining business initiative specific skills that are derived from the standard skills identified for any business initiative in general, in accordance with an embodiment of the invention.

FIG. 6 is a schematic block diagram illustrating a method of developing a learning event for providing education required to implement a business initiative, in accordance with an embodiment of the invention.

FIG. 7 is a schematic block diagram illustrating a method of establishing a job role skill set for developing education modules that provide education required to implement a business initiative, in accordance with an embodiment of the invention.

FIG. 8 is a schematic block system diagram illustrating a business initiative education and skill assessment computer program product for identifying educational content required to implement a business initiative, in accordance with an embodiment of the invention.

FIG. 9 is a schematic flowchart diagram illustrating the different solutions provided by a business initiative education and skill assessment tool, in accordance with an embodiment of the invention.

### BEST MODE FOR CARRYING OUT THE INVENTION

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the present invention provides a method for identifying educational content. The method comprises the steps of defining a business initiative having a framework with predefined levels of skill. Preferably, the predefined levels of skill include an overview level of skill, a foundation level of skill and an enhanced level of skill. The method further comprises, for each of the predefined levels of skill, identifying one or more standard skills required for each of a plurality of skilled workers who will be implementing the business initiative. Preferably, the step of identifying one or more standard skills step includes identifying, for each of the predefined levels of skill, the one or more professions that correspond to the plurality of skilled workers who will be deploying the business initiative, and further, for each of the one or more professions identified, the method includes identifying one or more associated disciplines and identifying one or more associated job roles for each of the one or more associated disciplines identified. Further, for each of the one or more standard skills identified for each of the plurality of skilled workers, the method further comprises determining whether any business initiative specific skills are required by any of the plurality of skilled workers who will be implementing the business initiative. In particular, the one or more business initiative specific skills are derived from the one or more standard skills identified for each of the skilled workers. Furthermore, the method comprises identifying at least one education module required to provide education for any business initiative specific skills determined to be required by at least one of the plurality of skilled workers for implementing the business initiative.

Preferably, the step of identifying at least one education module step includes establishing a job role skill set for each of the plurality of skilled workers, such that the job role skill set can be used to develop the one or more new education modules required to provide education for implementing the business initiative. More preferably, the step of identifying at least one education module includes the steps of performing an inventory of current education modules that can be used to provide education for implementing the business initiative and identifying gaps in the current education modules based on any business initiative specific skills determined to be required for implementing the business initiative. Further, the step of identifying at least one education module includes the step of grouping the one or more business initiative specific skills determined to be required for implementing the business initiative into one or more groups of business initiative specific skills, such that the at least one education module identified can provide education as to one of the one or more groups of business initiative specific skills.

In a preferred embodiment, the method further includes developing one or more new education modules required to provide education corresponding to the business initiative specific skills determined to be required for implementing the business initiative. Furthermore, the method preferably includes displaying the skill level of the educational content provided by the one or more new education modules developed to provide education for implementing the business initiative. More preferably, the method further comprises the step of entering into a tool each of the one or more standard skills identified to be required for the plurality of skilled workers who will be implementing the business initiative and entering into the tool each of any business initiative specific skills determined to be required by any of the plurality of skilled workers who will be implementing the business initiative.

As used herein, the term “business initiative” or “initiative” refers to any new business initiative or new business technique that is being deployed or implemented throughout the business or organization. Further, the term “predefined levels of skill” refers to one or more predefined levels of skill, where each predefined level of skill is categorized according to the level or depth of educational content to be disseminated to all the skilled workers in a particular predefined level of skill. Accordingly, all the skilled workers in a business are categorized as part of one of these predefined levels of skill. In particular, as used herein the “predefined levels of skill” refer to the overview level of skill, the foundation level of skill and the enhanced level of skill. However, the predefined levels of skill for a business initiative may be defined in other ways that are unique to a specific business or organization, such as, a basic level of skill, an intermediate level of skill and an advanced level of skill. Further, the term “skilled worker” refers to any professional that has one or more skills necessary for a given profession. The term “profession” refers to any field of work that requires specific knowledge and/or education, for instance, an IT Architect, a doctor, an electrician, etc. Further, the term “discipline(s)” refers to the different branches of a profession. For instance, an IT Infrastructure Architect is a discipline of IT Architect. Furthermore, the term “job role(s)” refers to the actual job or jobs that are performed by a profession in a given discipline. For example, one job role of an IT Infrastructure Architect is a Server Architect, and another job role is a Storage Architect. Also, as used herein, the term “standard or generic skills” refers to any generic skills that are necessary to perform a job role in a profession. For instance, for an IT Architect profession, one of the generic or standard skills is being able to develop a solution architecture. Further, the term “business initiative specific skills” or “initiative specific skills” refers to the specific skills that are necessary to deploy or implement a particular business initiative or business technique. For example, if the business initiative that is being deployed is an On-Demand business initiative, then an IT Architect needs to understand the components of an On-Demand business initiative in order to build an On-Demand solution architecture, which is a business initiative specific skill. Also, the term “education module” or “learning module” refers to a module that can provide education as to one or more closely-related skills for implementing a business initiative. The term “available education modules” or “current education modules” refers to any education or learning module that is currently available and can provide relevant education for deploying a business initiative. Further, the term “new education module(s)” refers to education modules that have to be developed to provide education to the skilled workers who will be deploying or implementing the business initiative or technique.

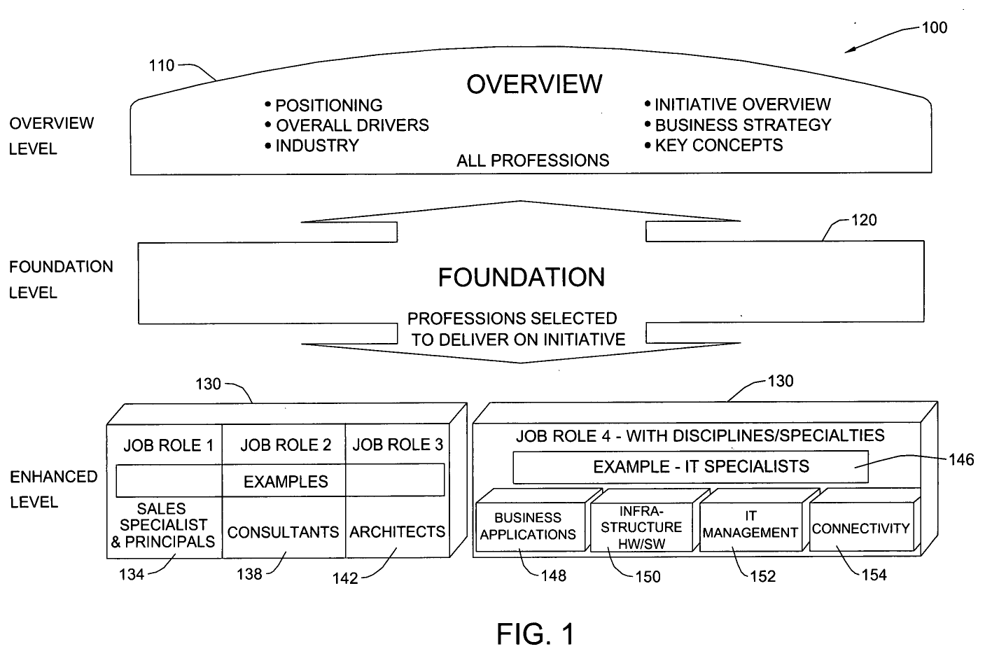

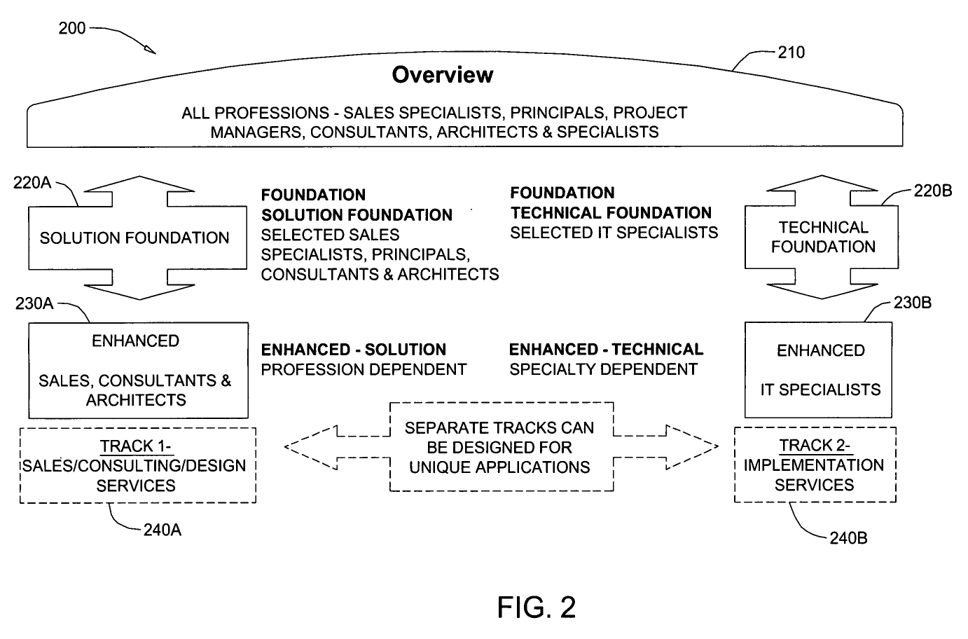

Reference is now made to FIGS. 1 and 2, where reference numbers 100 and 200, respectively, illustrate a plurality of predefined levels of skill that have been established for a business initiative or business technique. As shown in FIG. 1, the three predefined levels of skill for a business initiative are defined as an overview level of skill 110, a foundation level of skill 120 and an enhanced level of skill 130. In particular, the overview level of skill 110 is defined as comprising of all the skilled workers who will be implementing the business initiative or technique, which preferably includes all the professions impacted by the business initiative or technique. As mentioned herein above, each of the predefined levels of skill is categorized according to the depth or level of educational content that a skilled worker is construed to require in that particular predefined level of skill for deploying or implementing the business initiative or business technique. More particularly, as shown in FIG. 1, at the overview level of skill 110, the depth or level of educational content pertaining to the skills to be disseminated to the skilled workers correlates to providing education as to more general skills required by all the skilled workers, such as, positioning, overall drivers, industry, initiative overview, business strategy, and key concepts relating to the business initiative or technique. Similarly, at the foundation level of skill 120, the depth or level of educational content to be disseminated to the skilled workers correlates to providing education as to more targeted skills required by a subset or a select group of the skilled workers in the overview level 110. Preferably, the select group of skilled workers in the overview level of skill 110 are the skilled workers who will be supporting and/or deploying the defined business initiative or technique. As such, the depth or level of educational content established at the foundation level of skill 120 correlates to a more substantial level of skill identified for deploying or implementing the business initiative or technique. Further, at the enhanced level of skill 130, the depth or level of educational content to be disseminated to the skilled workers correlates to providing education as to precise skills required to actually execute, deliver, deploy or implement the business initiative or technique. Accordingly, the depth or level of educational content established at the enhanced level of skill 130 correlates to an even more substantial or tangible level of skill that is required to deploy or implement the business initiative or technique. In particular, as shown in the enhanced level of skill 130, the depth or level of educational content provided by education at the enhanced level is geared towards the disciplines/specialties in a given profession and, preferably, with the various job roles associated with the corresponding disciplines/specialties. So the main idea at the enhanced level of skill 130 is to actually execute, deliver, deploy or implement the business initiative or technique.

Turning to FIG. 2, reference number 200 shows an example of the make-up or composition of the predefined levels of skill in a business initiative or business technique that can be applied to any new business initiative being deployed. The overview level of skill 210 shows that any educational content provided at this level 210 is geared towards all the professions, for example, Sales Specialists, Principals, Project Managers, Consultants, Architects, and IT Specialists. The professions listed in FIG. 2 are merely examples and, as such, this method can be used for any other profession. Also, as shown in FIG. 2, the foundation level of skill can be further divided into a Solution foundation level of skill 220A and a Technical foundation level of skill 220B. The Solution foundation level of skill 220A includes one or more profession(s) selected from the professions identified in the overview level of skill 210, namely, the Sales Specialists, Principals, Consultants and Architects, whereas, the Technical foundation level of skill 220B includes the remaining profession(s) selected from the professions identified in the overview level of skill 210, in this case, the IT Specialists. Further, the enhanced level of skill can be divided also into a Solution enhanced level of skill 230A and a Technical enhanced level of skill 230B. The Solution enhanced level of skill 230A includes one or more profession(s) selected from the professions identified in the foundation level of skill 220A, namely, the Sales Specialists, Consultants and Architects, and whereas, the Technical enhanced level of skill 230B includes the IT Specialists. As such, separate education modules or tracks 1 and 2 (240A and 240B, respectively) can be designed for the Solution and Technical applications. For instance, track 1, reference number 240A can provide one or separate modules on sales, consulting and/or design services, and track 2, 240B can provide an education module on implementation services.

In another embodiment, the invention provides a method for developing educational content for deploying a business initiative or business technique. The method comprises the steps of defining a business initiative, wherein a plurality of predefined levels of skill are established for deploying the business initiative. Preferably, the plurality of predefined levels of skill comprises an overview level, a foundation level and an enhanced level. The method further comprises, for each of the predefined levels of skill, identifying one or more standard skills for each of a plurality of skilled workers who will be deploying the business initiative. Further, for each of the one or more standard skills identified for each of the plurality of skilled workers, determining whether any business initiative specific skills are required for any of the plurality of skilled workers who will be deploying or implementing the business initiative, where preferably any of the business initiative specific skills determined to be required are derived from the one or more standard skills identified for each of the plurality of skilled workers. The method further includes the steps of identifying educational gaps in available educational content for providing education as to any business initiative specific skills determined to be required for any of the plurality of skilled workers who will be deploying or implementing the business initiative and developing one or more new education modules based on the educational gaps identified, such that the one or more new education modules provide education for one or more of the plurality of skilled workers as to any business initiative specific skills determined to be required in order to deploy the business initiative.

Preferably, the step of identifying one or more standard skills step includes identifying for each of the plurality of predefined levels of skill one or more professions for the plurality of skilled workers who will be deploying the business initiative. Further, for each of the one or more professions identified, the method includes identifying one or more disciplines associated with each of the one or more professions identified, and furthermore, for each of the one or more disciplines identified, the method includes identifying one or more associated job roles, preferably, for each one of the plurality of skilled workers who will be implementing the business initiative. Preferably, the step of identifying educational gaps includes the steps of performing an inventory of available education modules that can be used to provide education for implementing the business initiative. Further, preferably, the step of developing one or more new education modules includes the steps of establishing a job role skill set for each of the plurality of skilled workers, such that the job role skill set can be used to develop the one or more new education modules. More preferably, the developing step includes grouping any of the business initiative specific skills determined to be required into one or more groups of business initiative specific skills, such that each of the one or more new education modules developed provides education as to at least one of the one or more groups of business initiative specific skills and, further, displaying a skill level for educational content provided by each of the one or more new education modules.

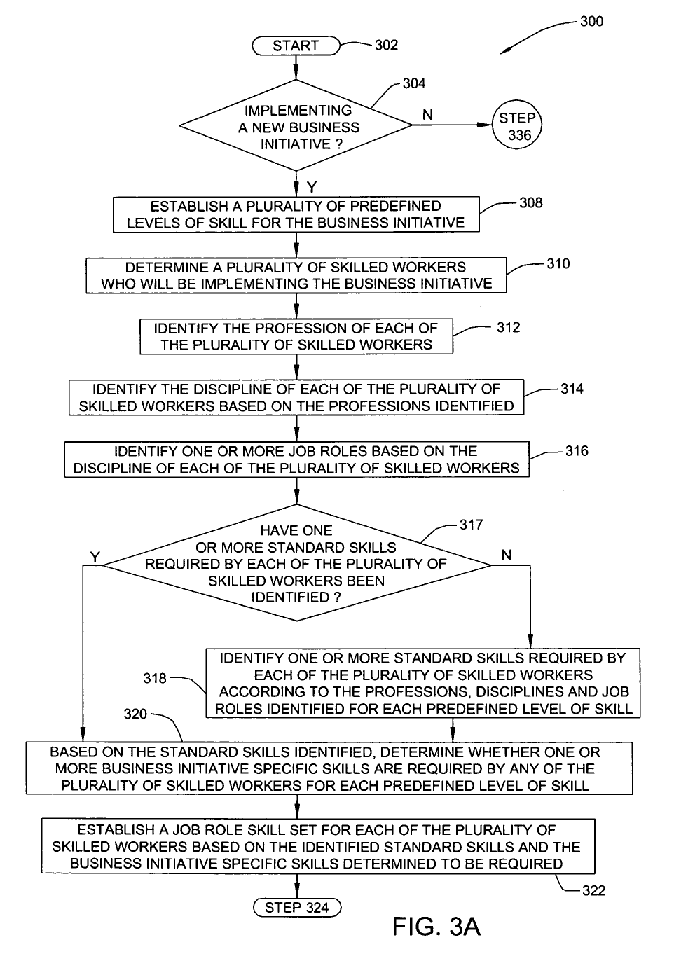

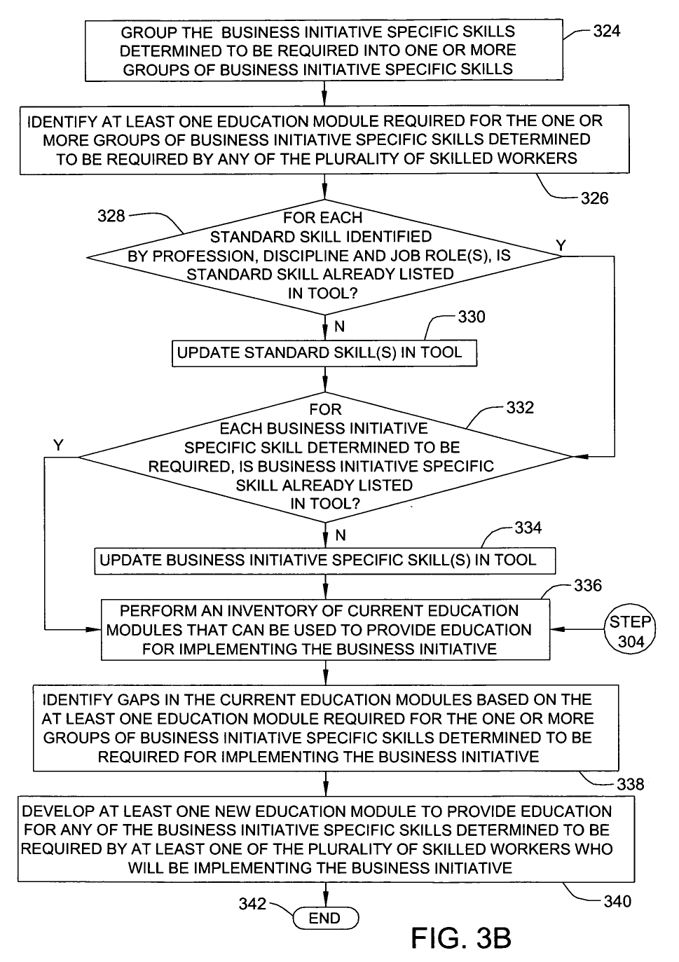

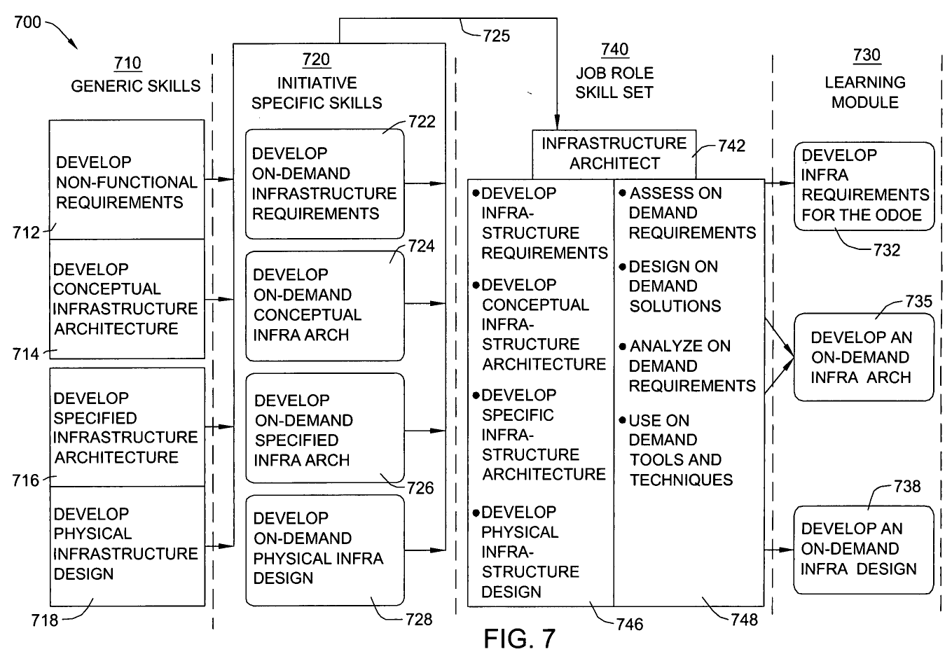

Turning to reference number 300 in FIGS. 3A and 3B, FIGS. 3A and 3B together outline a method of developing educational content for implementing or deploying a business initiative or technique. Starting at step 302 of FIG. 3A, the first step in identifying educational content for implementing a business initiative or business technique is to determine whether or not the business initiative is new or whether it is an existing business initiative or technique, as shown in step 304. If it is determined that the business initiative or technique is an existing one, the method proceeds to step 336, which is discussed herein below. However, if the business initiative or technique is new, the next step 308 is to establish or determine one or more predefined levels of skill for that particular business initiative or technique, where each of the predefined levels of skill correspond to the anticipated level or depth of educational content required for deploying or implementing the business initiative or technique throughout the organization. Further, in step 310, the method further includes determining for each of the predefined levels of skill, the skilled workers who will be implementing the business initiative or technique. Furthermore, the method includes the step of identifying the profession of each of the skilled workers in step 312 for each of the predefined levels of skill. Further yet, in step 314, the method includes identifying the associated disciplines corresponding to each of the professions identified in step 312. The method further includes in step 316, identifying one or more job roles corresponding to each of the associated disciplines identified in step 314. In addition, in step 317, the method further includes determining whether one or more standard skills have been identified for each of the skilled workers based on the profession, discipline and job role(s). Since these standard or generic skills may be defined or identified at the onset of a new business initiative or can be defined apart from any business initiative, if the standard skills have been identified according to the different professions, the corresponding disciplines associated with the professions and/or job roles corresponding to the respective disciplines, then the standard skills that have been identified are used to determine in step 320 whether any business initiative specific skills are required by any of the skilled workers to implement or deploy the business initiative or technique. However, if the standard skills have not been identified, then in step 318, one or more standard skills are identified for each of the plurality of skilled workers according to the professions, disciplines and job roles for each of the predefined level of skill. Once, the standard skills have been identified in step 318, these standard skills are used to determine the business initiative specific skills that are required by the skilled workers in step 320. Preferably, the next step 322 of the method includes establishing a job role skill set for each of the skilled workers, such that the job role skill set includes the standard skills identified as well as any business initiative specific skills determined to be required (as will be explained further with respect to FIG. 7). Additionally, as continued in FIG. 3B, the method includes grouping in step 324 the business initiative specific skills determined to be required into one or more groups of business initiative specific skills. Further, the method includes in step 326 identifying at least one education module required for the one or more groups of business initiative specific skills determined to be required by any of the skilled workers for implementing the business initiative or technique.

Preferably, the method includes determining in step 328 whether the standard skills identified are listed already in a computer tool designed to store such information. If the standard skills are listed in the computer tool, the next step 332 includes determining whether the business initiative specific skills identified are listed already in the computer tool. However, if it is determined that the standard skills are not listed in the computer tool in step 328, the method includes entering and updating the list of standard skills in the computer tool, as per step 330. Similarly, if it is determined that the business initiative specific skills are not listed in the computer tool in step 332, the method includes entering and updating the list of business initiative specific skills in the computer tool, as per step 334. In particular, the updating steps 328 and 332 ensure that the computer tool can provide up-to-date information as to the skills required to deploy or implement a given business initiative. Further, in step 336, the method includes performing an inventory of current education modules that can be used to provide education for implementing the business initiative or technique, and identifying gaps in the current education modules based on the one education module identified to be required for the one or more groups of business initiative specific skills determined to be required by any of the skilled workers in step 338. Furthermore, the method includes developing at least one new education module to provide education for any of the business initiative specific skills determined to be required by at least one of the skilled workers who will be implementing the business initiative or technique.

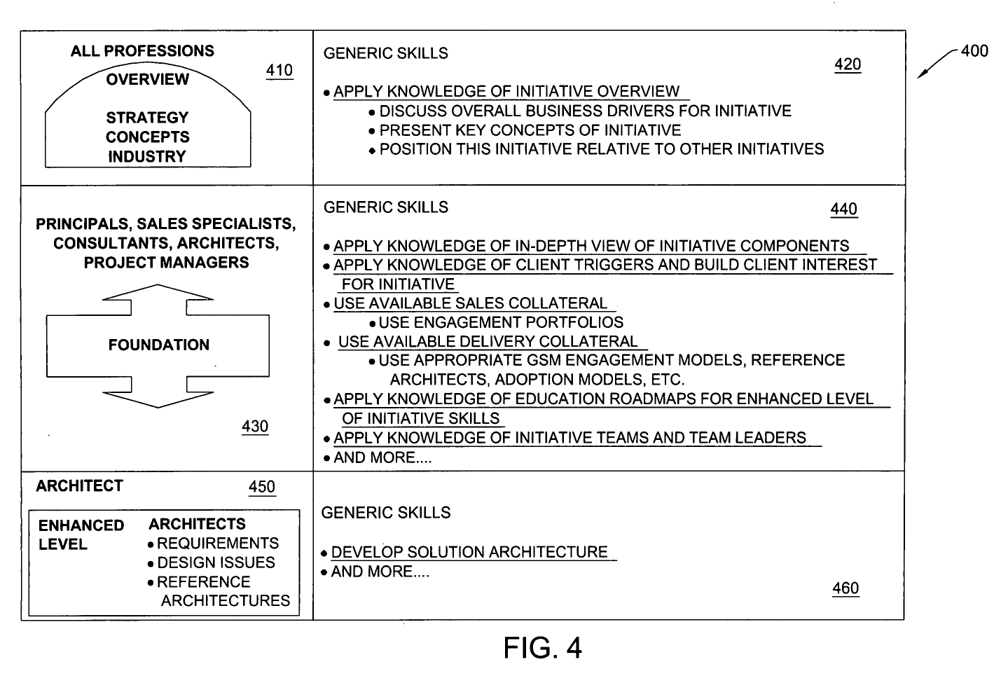

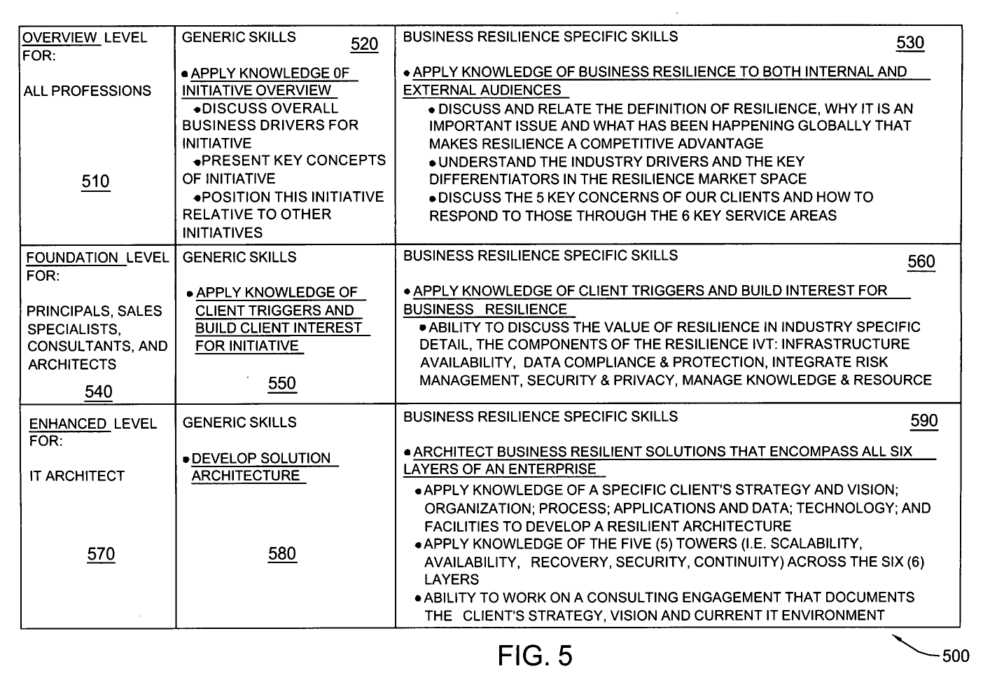

Reference is now made to FIGS. 4 and 5, where reference number 400 outlines the step of identifying standard skills for implementing any business initiative in general. Further, reference number 500 in FIG. 5 outlines the steps for determining any business initiative specific skills required based on the standard skills identified for any business initiative. In particular, FIG. 5 shows applying the standard skills identified for any business initiative to a specific business initiative, such as, a Business Resilience business initiative. Turning to FIG. 4, the three predefined levels of skill established for any business initiative are an overview level of skill 410, a foundation level of skill 430 and an enhanced level of skill 450. In particular, standard or generic skills are identified in rectangle 420 for the overview level of skill 410. As shown in FIG. 4, the education for the standard or generic skills at the overview level of skill 410 focuses on factors, such as, the overall strategy, concepts and industry for the initiative. For instance, a standard skill identified in 420 for the overview level of skill 410 is “Apply knowledge of initiative overview”, which identifies other standard skills in 420, such as discuss overall business drivers for initiative, present key concepts of initiative, etc. Further, standard or generic skills are identified also for the foundation level of skill 430, shown in rectangle 440. In particular, the education for the standard or generic skills at the foundation level of skill 430 focuses on the different professions of the skilled workers already identified (in steps 310 and 312 of FIG. 3) for implementing the business initiative, such as, the Principals, Sales Specialists, Consultants, Architects, Project Managers, etc. For instance, a couple of the standard skills identified in 440 for the foundation level of skill 430 is “Apply knowledge of in-depth view of initiative components” and “Apply knowledge of client triggers and build client interest for initiative”. Additionally, standard or generic skills are identified for the enhanced level of skill 450, shown in rectangle 460. The identifying of education at the enhanced level of skill 450 focuses not only on the professions involved, but also focuses on the associated disciplines/specialties and/or the job roles(s) involved and, as such, the educational requirements for the enhanced level of skill 450 is more in-depth. In particular, the example shown in 450 uses the profession of Architects and the various requirements, design issues, etc. As such, a standard or generic skill identified for Architects is “Develop Solution Architecture”. Similarly, other generic or standard skills can be identified (referred to as “and more . . . ” in 460) based on the professions, the disciplines and/or job role(s) of the workers who will be deploying the business initiative at the enhanced level of skill 450. Alternatively, as mentioned hereinabove, these standard or generic skills may be defined or identified at the onset of a new business initiative or can be defined apart from any business initiative. In particular, the list of standard skills may be predefined according to the different professions, the corresponding disciplines associated with the professions and/or job roles corresponding to the respective disciplines.

Turning to FIG. 5, reference number 500 shows a side-by-side outline of the generic or standard skills identified for the Business Resilience initiative and the business initiative specific skills identified for any business initiative by professions, disciplines and/or job roles and shows how the generic skills identified in FIG. 4 can be applied to derive the business initiative specific skills for a particular business initiative, such as, the Business Resilience initiative. Similar to identifying standard skills at the overview level 410, the education for the business initiative specific skills at the overview level of skill 510 focuses on factors, such as, the overall strategy, concepts and industry for the initiative. The generic or standard skills from 420 in FIG. 4 are shown listed in 520, whereas, the Business Resilience specific skills are identified in rectangle 530 for the overview level of skill 510. In particular, as shown in FIG. 5, the specific skills are derived from or determined based on the generic or standard skills listed in 520. For instance, the business initiative specific skill “Apply knowledge of Business Resilience to both internal and external audiences” listed in 530 is determined from or derived from the already identified generic skill “Apply knowledge of initiative overview” in 520. Similarly, each of the other Business Resilience specific skills listed in 530 is determined from or derived from a corresponding one of the generic or standard skills identified in 520. Further, business initiative specific skills are identified also for the foundation level of skill 540. In particular, the education for the business initiative specific skills at the foundation level of skill 540 focuses on examples of the different professions, such as, the Principals, Sales Specialists, Consultants, Architects, Project Managers, etc. Again, the professions listed in FIG. 5 are merely examples and, as such, this method can be used to identify business initiative specific skills for any other profession. For instance, one of the business initiative specific skills identified in 560 for the foundation level of skill 550 is “Apply knowledge of client triggers and build interest for Business Resilience”. This specific skill is determined from the generic or standard skill “Apply knowledge of client triggers and build client interest for initiative” listed in 550. Further, the other specific skills listed in 560 (“Ability to discuss the value of resilience in industry specific detail”, etc.) are also determined from the one generic skill listed in 550. Although, the other generic skills listed in 440 of FIG. 4 for the foundation level of skill 430 are not shown in FIG. 5, the same procedure is applied to these other generic skills to determine the specific skills required for the business initiative. Turning to the enhanced level of skill 570 in FIG. 5, the business initiative specific skills listed in 590, such as “Architect business resilient solutions that encompass all six layers of an enterprise” are determined from or correspond to the generic skill “Develop Solution Architecture” identified in 580. Again, the identifying of education at the enhanced level of skill 570 focuses not only on the professions involved (IT Architect), but also focuses on the associated disciplines/specialties and/or the job roles(s) involved (not listed in FIG. 5). As such, the educational requirements for the enhanced level of skill 570 is more in-depth.

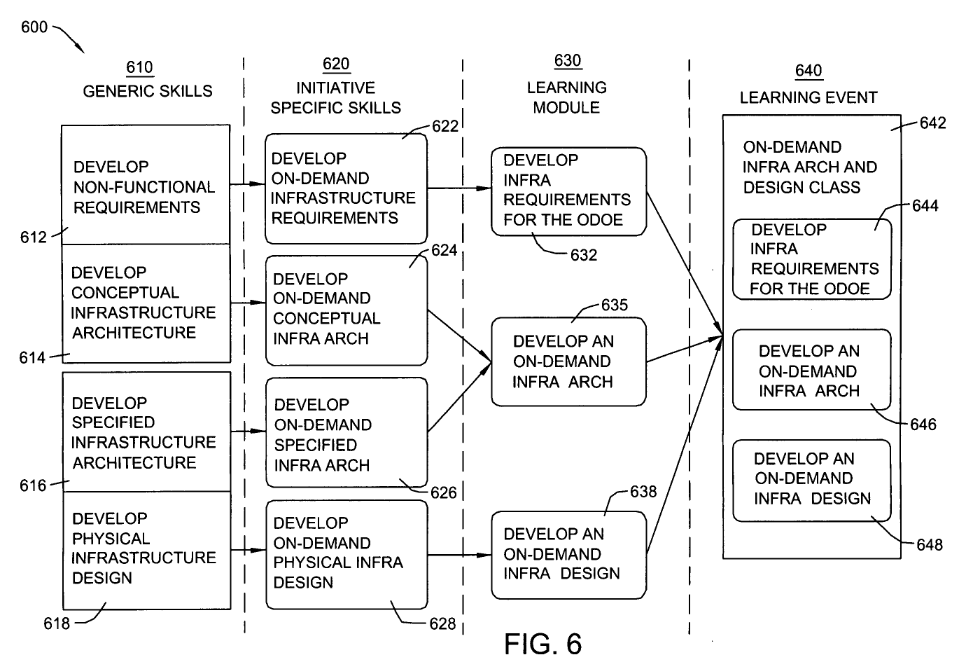

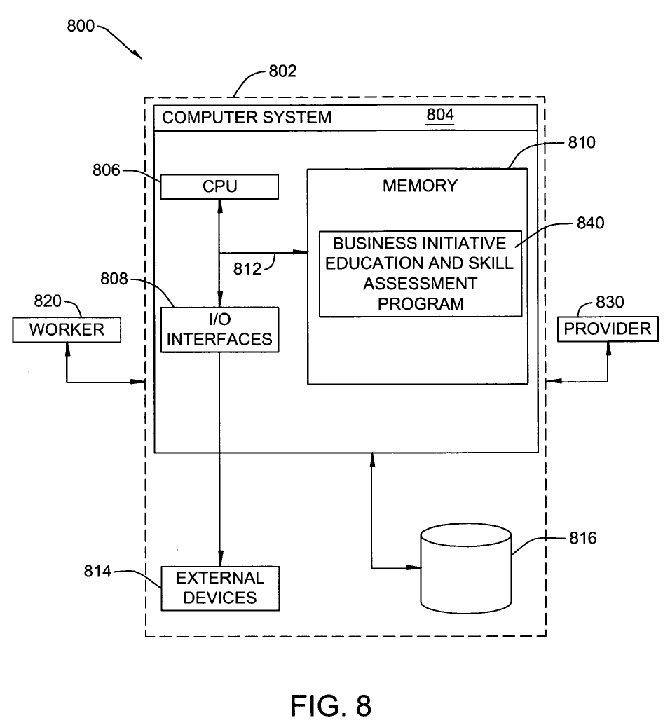

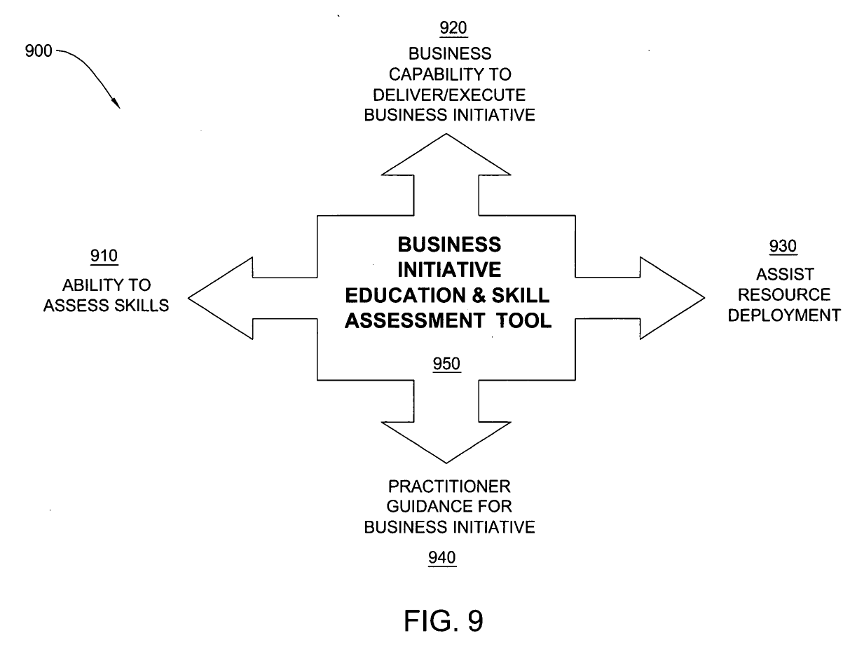

Turning to FIGS. 6 and 7, the reference numbers 600 and 700, respectively, show the next steps involved after the business initiative specific skills have been derived or determined from the standard skills. In particular, FIGS. 6 and 7 apply the method shown in FIGS. 4 and 5 for identifying and/or developing educational content for a different business initiative, namely, an On-Demand business initiative. In FIGS. 6 and 7, in some instances, the abbreviated term “Infra” is used for “Infrastructure” and the abbreviated term “Arch” is used for “Architecture”. As shown in column 610, the standard or generic skills 612-618 are identified for any business initiative in general based on the professions, disciplines and/or job roles. Again, these standard or generic skills may be defined or identified at the onset of a new business initiative or can be defined apart from any business initiative. After the generic skills have been identified (as shown in column 610), the generic skills are applied to a specific business initiative, in this case, the On-Demand business initiative, in order to determine the unique On-Demand business initiative specific skills 622-628 (listed in column 620) necessary for implementing the On-Demand business initiative. For instance, the generic skill “Develop Non-functional Requirements” in 612 is used to determine the business initiative specific skill “Develop On-Demand Infrastructure Requirements” in 622. Similarly, the “Develop Conceptual Infrastructure Architecture” in 614 is used to derive the business initiative specific skill “Develop On-Demand Conceptual Infrastructure Architecture” in 624. Once the generic skills have been identified and the business initiative specific skills have been determined, the business initiative specific skills in column 620 are then grouped, if possible, to identify one or more learning or education modules as shown in column 630. In particular, the business initiative specific skills listed in 624 and 626 have been grouped to form the education or learning module listed in 635. However, the business initiative specific skill listed in 622 and 628 are not capable of being grouped, thus, the separate and respective learning modules 632 (Develop Infrastructure Requirements for the ODOE (On-Demand Operating Environment)), 635 (Develop an On-Demand Infrastructure Architecture) and 638 (Develop an On-Demand Infrastructure Design) are identified in column 630. Further, once the learning modules have been identified in column 630, an inventory is performed of current or available education or learning modules to identify any gaps in the available education modules that is required for implementing the business initiative. Preferably, the current or available education modules are listed in a computer tool (as discussed with FIGS. 8 and 9 herein below), such that performing an inventory is facilitated. As such, as shown in column 640, each of the three learning or education modules 632 (Develop Infrastructure Requirements for the ODOE (On-Demand Operating Environment)), 635 (Develop An On-Demand Infrastructure Architecture) and 638 (Develop an On-Demand Infrastructure Design) identified in column 630 can be made available in the form of a learning event in column 640 called “On-Demand Infrastructure Architecture and Design class” 642. A learning event refers to the form in which education modules are delivered to professionals. Preferably, the learning event can comprise one or more of the following: classes, web lectures, live presentations and or distance learning classes. For example, as shown in FIG. 6, the class on “On-Demand Infrastructure Architecture and Design Class” 642 includes the learning modules “Develop Infrastructure Requirements for the ODOE” (reference number 644), “Develop an On-Demand Infrastructure Architecture” (reference number 646) and “Develop an On-Demand Infrastructure Design” (reference number 648).

Further, referring to the example (reference number 700) of FIG. 7, the generic skills 712, 714, 716 and 718 identified for the On-Demand business initiative (listed in column 710) are used to determine or derive the business initiative specific skills 722, 724, 726 and 728 (listed in column 720) for the On-Demand business initiative. Further, the business initiative specific skills 722, 724, 726 and 728 along with the generic skills listed in column 710 are used to establish a job role skill set 740. In particular, FIG. 7, shows a job role skill set 740 that is developed for the profession of an Infrastructure Architect 742, which is based on both the generic skills and the business initiative specific skills derived from the generic skills and is mapped (shown by the arrow 725) on to the various job roles of the Infrastructure Architect listed in columns 746 and 748. As such, the learning or education modules “Develop Infrastructure Requirements for the ODOE” (reference number 732), “Develop an On-Demand Infrastructure Architecture” (reference number 735) and “Develop an On-Demand Infrastructure Design” (reference number 738) shown in column 730 can be developed to match the job roles to specific skills for a given profession, as shown in FIG. 7. Also, preferably, each of the education modules 730 developed by this method displays a skill level of the educational content provided by the education module, so that a professional can assess whether the level of skill provided by an education module is appropriate or not.

In yet another embodiment, the invention provides a computer program product for identifying educational content for implementing a business initiative. The computer program product comprises a computer readable or computer-usable medium, which provides program codes or instructions for use by or in connection with a computer or any instruction execution system. In a preferred embodiment, the computer program product further comprises first program instructions to access a set of skilled worker skills for a skilled worker among a plurality of skilled workers who will be implementing the business initiative. Preferably, the set of skilled worker skills comprises standard skills that are established or predefined for each of the skilled workers and/or any business initiative specific skills that are determined to be required by any of the plurality of skilled workers for deploying the business initiative. The first program instructions include instructions to receive in a memory one or more standard skills for each skilled worker among the plurality of skilled workers for implementing the business initiative and to receive in the memory any business initiative specific skills required for any of the plurality of skilled workers who will be implementing the business initiative. Further, the computer program product comprises second program instructions to assess individual skill levels of the skilled worker with respect to the set of skilled worker skills accessed for implementing the business initiative. The second program instructions include instructions to provide a list of available skilled workers for a job role, such that any one skilled worker on the list of available skilled workers for a job role, such that any one of the skilled workers on the list can implement the business initiative. Furthermore, the computer program product comprises third program instructions to identify whether any education modules are required by the skilled worker based on the individual skill levels assessed for that skilled worker who will be implementing the business initiative. Preferably, the third program instructions include instructions to perform an inventory of available education modules to identify any gaps in the available education modules for determining any new education modules required for implementing the business initiative. Moreover, the computer program product further comprises fourth program instructions to evaluate a set of business factors pertaining to the capability of a business to implement the business initiative. Preferably, each of the first, second, third and fourth program instructions are stored on the computer readable medium.

Preferably, the computer program product is in a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can comprise an electronic, magnetic, optical, electromagnetic, infrared, or semiconductor system (or apparatus or device) or a propagation medium. More preferably, the computer-readable medium can comprise a semiconductor or solid state memory, magnetic tape, a removable computer diskette, a random access memory (RAM), a read-only memory (ROM), a rigid magnetic disk and an optical disk. Further, examples of optical disks include compact disc—read only memory (CD-ROM), compact disc—read/write (CD-R/W) and digital versatile/video disc (DVD).

Referring now to FIG. 8, there is illustrated a business initiative education and skill assessment system 800, according to the present invention. As depicted, system 800 includes a computer infrastructure 802, which is intended to represent any type of computer architecture that is maintained in a secure environment (i.e., for which access control is enforced). As shown, infrastructure 802 includes a computer system 804 that typically represents a server or the like. It should be understood, however, that although not shown, other hardware and software components (e.g., additional computer systems, routers, firewalls, etc.) could be included in infrastructure 802.

In general, a worker or practitioner 820 interfaces with infrastructure 802 to electronically identify skills and/or educational content necessary for implementing a business initiative or technique. Similarly, a resource provider 830 that provides a service (preferably, a service that is provided on a fee or subscription basis) to a worker or practitioner can interface with infrastructure 802 to electronically identify skills and/or educational content for implementing a business initiative or technique. To this extent, infrastructure 802 provides a secure environment. In general, the parties could access infrastructure 802 directly, or over a network via interfaces (e.g., web browsers) loaded on computerized devices (e.g., personal computers, laptops, handheld devices, etc. not shown in FIG. 8). In the case of the latter, the network can be any type of network such as the Internet, a local area network (LAN), a wide area network (WAN), a virtual private network (VPN), etc. In any event, communication with infrastructure 802 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 802. It should be understood that under the present invention, infrastructure 802 could be owned and/or operated by a party such as provider 830, or by an independent entity. Regardless, use of infrastructure 802 and the teachings described herein could be offered to the parties on a subscription or fee-basis. In either scenario, an administrator (not shown in FIG. 8) could support and configure infrastructure 802.

Computer system 804 is shown to include a CPU (hereinafter “processing unit 806”), a memory 810, a bus 812, and input/output (I/O) interfaces 808. Further, computer system 800 is shown in communication with external I/O devices/resources 814 and storage system 816. In general, processing unit 806 executes computer program code, such as the business initiative education and skill assessment program 840, which is stored in memory 810 and/or storage system 816. While executing computer program code, processing unit 806 can read and/or write data, to/from memory 810, storage system 816, and/or I/O interfaces 808. Bus 812 provides a communication link between each of the components in computer system 800. External devices 814 can comprise any devices (e.g., keyboard, pointing device, display, etc.) that enable a user to interact with computer system 800 and/or any devices (e.g., network card, modem, etc.) that enable computer system 800 to communicate with one or more other computing devices.

Computer infrastructure 802 is only illustrative of various types of computer infrastructures for implementing the invention. For example, in one embodiment, computer infrastructure 802 comprises two or more computing devices (e.g., a server cluster) that communicate over a network to perform the various process steps of the invention. Moreover, computer system 800 is only representative of various possible computer systems that can include numerous combinations of hardware. To this extent, in other embodiments, computer system 800 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 806 may comprise a single processing unit, or be distributed across one or more processing units in one or more locations, e.g., on a client and server. Similarly, memory 810 and/or storage system 816 can comprise any combination of various types of data storage and/or transmission media that reside at one or more physical locations. Further, I/O interfaces 808 can comprise any system for exchanging information with one or more external devices 814. Still further, it is understood that one or more additional components (e.g., system software, math co-processing unit, etc.) not shown in FIG. 8 can be included in computer system 800. However, if computer system 800 comprises a handheld device or the like, it is understood that one or more external devices 814 (e.g., a display) and/or storage system(s) 816 could be contained within computer system 800, not externally as shown.

Storage system 816 can be any type of system (e.g., a database) capable of providing storage for information under the present invention. To this extent, storage system 802 could include one or more storage devices, such as a magnetic disk drive or an optical disk drive. In another embodiment, storage system 816 includes data distributed across, for example, a local area network (LAN), wide area network (WAN) or a storage area network (SAN) (not shown). Although not shown, additional components, such as cache memory, communication systems, system software, etc., may be incorporated into computer system 800. Shown in memory 810 of computer system 800 is a business initiative education and skill assessment program 840 (hereinafter program 840). Under the present invention, program 840 allows identifying educational content for implementing a business initiative or technique.

Turning to FIG. 9, reference number 900 in FIG. 9 illustrates a business initiative education and skill assessment tool 950 into which the various generic skills identified for a business initiative and the various business initiative specific skills that are determined for the business initiative are entered and stored, such that the skills required for a particular skilled worker can be accessed. Preferably, a professional or practitioner can go into the tool 950, which provides the ability to assess their own individual skill levels 910 based on the generic and specific skills that are loaded in the tool for a particular profession, discipline and/or job role for a business initiative. In particular, a professional can access the tool 950 and can have the ability to asses their skill levels, for instance, on a scale of 1 to 3 (where 1 is a beginner and 3 is an expert). Further, the tool 950 provides practitioner guidance 940 as far as identifying whether any new education modules need to be developed for the business initiative. Furthermore, the tool 950 aids in evaluating the business capability to deliver or execute a business initiative 920 by evaluating a set of business factors, such as does an organization or business have the right number of trained people, does the business need to invest more money in training, etc. Additionally, the tool 950 provides assistance in resource deployment 930, such as, providing a list of available skilled workers for a particular profession or discipline or job role who are capable of deploying the business initiative.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for identifying educational content, said method comprising the steps of:
defining a business initiative having a framework with predefined levels of skill;
for each of said predefined levels of skill, identifying one or more standard skills required for each of a plurality of skilled workers;
for each of said one or more standard skills identified for said each of said plurality of skilled workers, determining whether any business initiative specific skills are required by any of said plurality of skilled workers who will be implementing said business initiative, wherein said any business initiative specific skills are derived from said one or more standard skills identified for each skilled worker; and
identifying at least one education module required to provide education for said any business initiative specific skills determined to be required by at least one of said plurality of skilled workers for implementing said business initiative.

2. A method according to claim 1, further comprising the step of:
developing one or more new education modules required to provide education corresponding to said any business initiative specific skills determined to be required for implementing said business initiative.

3. A method according to claim 2, further comprising the step of:
displaying a skill level of educational content provided by said one or more new education modules developed to provide education for implementing said business initiative.

4. A method according to claim 3, wherein said predefined levels of skill comprises at least one of: an overview level, a foundation level and an enhanced level.

5. A method according to claim 3, wherein said identifying one or more standard skills step includes the steps of:
for each of said predefined levels of skill, identifying one or more professions for said plurality of skilled workers who will be implementing said business initiative;
for each of said one or more professions identified, identifying one or more associated disciplines; and
for each of said one or more associated disciplines identified, identifying one or more associated job roles.

6. A method according to claim 3, wherein said identifying at least one education module step includes the step of:
establishing a job role skill set for each of said plurality of skilled workers, such that said job role skill set can be used to develop said one or more new education modules required to provide education for implementing said business initiative.

7. A method according to claim 3, wherein said identifying at least one education module step includes the steps of:
performing an inventory of current education modules that can be used to provide education for implementing said business initiative; and
identifying gaps in said current education modules based on said any business initiative specific skills determined to be required for implementing said business initiative.

8. A method according to claim 3, wherein said identifying at least one education module step includes the step of:
grouping said one or more business initiative specific skills determined to be required for implementing said business initiative into one or more groups of business initiative specific skills, such that said at least one education module identified can provide education as to one of said one or more groups of business initiative specific skills.

9. A method according to claim 3, further comprising the steps of:
entering into a tool each of said one or more standard skills identified for said plurality of skilled workers who will be implementing said business initiative; and
entering into said tool each of said any business initiative specific skills determined to be required by any of said plurality of skilled workers who will be implementing said business initiative.

10. A method for developing educational content for deploying a business initiative, said method comprising the steps of:
defining a business initiative, wherein a plurality of predefined levels of skill are established for said business initiative;
for each of said predefined levels of skill, identifying one or more standard skills for each of a plurality of skilled workers;
for each of said one or more standard skills identified for said each of said plurality of skilled workers, determining whether any business initiative specific skills are required for any of said plurality of skilled workers for deploying said business initiative;
identifying educational gaps in available educational content for providing education as to said any business initiative specific skills determined to be required for said any of said plurality of skilled workers for deploying said business initiative; and
developing one or more new education modules based on said educational gaps identified, such that said one or more new education modules provide education for one or more of said plurality of skilled workers as to said any business initiative specific skills determined to be required for deploying said business initiative.

11. A method according to claim 10, wherein said identifying one or more standard skills step includes the steps of:
for each of said plurality of predefined levels of skill, identifying one or more professions for said plurality of skilled workers for deploying said business initiative;
for each of said one or more professions identified, identifying one or more associated disciplines; and
for each of said one or more associated disciplines identified, identifying one or more associated job roles.

12. A method according to claim 10, wherein said identifying educational gaps step includes the step of:
performing an inventory of said available education modules that can be used to provide education for deploying said business initiative.

13. A method according to claim 10, wherein said developing step includes the steps of:
grouping said any business initiative specific skills determined to be required into one or more groups of business initiative specific skills, such that each of said one or more new education modules developed provides education as to at least one of said one or more groups of business initiative specific skills; and
displaying a skill level for educational content provided by each of said one or more new education modules.

14. A method according to claim 10, wherein said plurality of predefined levels of skill comprises at least one of: an overview level, a foundation level and an enhanced level.

15. A computer program product for identifying educational content for implementing a business initiative, said computer program product comprising:
a computer readable medium;
first program instructions to access a set of skilled worker skills required for a skilled worker among a plurality of skilled workers;
second program instructions to assess individual skill levels of said skilled worker with respect to said set of skilled worker skills accessed for implementing said business initiative;
third program instructions to identify whether any education modules are required by said skilled worker based on said individual skill levels assessed for said skilled worker who will be implementing said business initiative; and wherein said first, second and third program instructions are stored on said medium.

16. A computer program product according to claim 15, further comprising:
fourth program instructions to evaluate a set of business factors pertaining to the capability of a business to implement said business initiative, and wherein said fourth program instructions are stored on said medium.

17. A computer program product according to claim 15, wherein said set of skilled worker skills comprises: standard skills required for said each skilled worker among said plurality of skilled workers, and business initiative specific skills required by any of said plurality of skilled workers for implementing said business initiative.

18. A computer program product according to claim 17, wherein said first program instructions include instructions to receive in a memory one or more standard skills required for each skilled worker among said plurality of skilled workers for implementing said business initiative and to receive in said memory any business initiative specific skills required for any of said plurality of skilled workers who will be implementing said business initiative.

19. A computer program product according to claim 17, wherein said second program instructions include instructions to provide a list of available skilled workers for a job role, such that any worker on said list of available skilled workers can implement said business initiative.

20. A computer program product according to claim 17, wherein said third program instructions include instructions to perform an inventory of available education modules to identify gaps in said available education modules for determining any new education modules required for implementing said business initiative.
